(19) United States
(12) Patent Application Publication
(10) Pub. No.: US 2008/0177920 A1
(43) Pub. Date: Jul. 24, 2008

(54) Methods for Handling Keyboard Inputs

(75) Inventor: Lowell Dennis, Pllugerville, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/626,532

(22) Filed: Jan. 24, 2007

(51) Int. Cl. G06F 13/36; G06F 21/22

(52) U.S. Cl. 710/200; 726/19

(57) ABSTRACT

A computer implemented method of processing keyboard input, the method including receiving a keyboard type of a keyboard coupled an information handling system, receiving keyboard input from the keyboard and processing the keyboard input as a function of the keyboard type.

### BACKGROUND

1. Technical Field

The present disclosure relates generally to information handling systems and, more particularly, to keyboard inputs.

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system (IHS) keyboard is a peripheral partially modeled after the typewriter keyboard. Keyboards are designed for the input of text and characters and also to control the operation of an HIS. Physically, computer keyboards are an arrangement of rectangular or near-rectangular buttons, or “keys.” Keyboards typically have characters engraved or printed on the keys; in most cases, each press of a key corresponds to a single written symbol. However, to produce some symbols requires pressing and holding multiple keys simultaneously or in sequence; other keys do not produce any symbol, but instead affect the operation of the computer or the keyboard itself.

When a key is pressed on a keyboard of an information handling system, a scan code, which identifies the row and column of the key that was pressed, is generated. Mapping key positions by row and column requires less complex computer hardware; therefore, in the past, using software or firmware to translate the scan codes to text characters was less expensive than wiring the keyboard by text character. This cost difference is not as profound as it used to be. However, many types of computers still use their traditional scan codes to maintain backward compatibility.

A scan code is the data that most computer keyboards send to a computer to report which keys have been pressed. A number, or sequence of numbers, is assigned to each key on keyboard. Some keyboard standards include a scan code for each key being pressed and a different one for each key being released. In addition, many keyboard standards (for example, IBM PC compatible standards) allow the keyboard itself to generate “typematic” repeating keys by having the keyboard itself generate the pressed-key scan code repeatedly while the key is held down, with the release scan code sent once when the key is released.

In the case of differing keyboard layouts, particularly when comparing a standard PS/2 keyboard (“PS/2 keyboard” means a U.S English PS/2 keyboard unless otherwise designated) with foreign or international keyboards, certain common keys are located in different places on the differing keyboards. Therefore, scan codes may not be completely reliable in identifying particular keys across the different keyboard layouts. Furthermore, there is no method by which the operating system (OS) or Basic Input/Output System (BIOS) can determine the layout of the keys on a PS/2 keyboard.

The BIOS will usually store keyboard inputs (e.g., password) as a series of hashed scan codes. International or foreign keyboards may present a problem for the BIOS in the case of inputting passwords. For example, a user may originally enter a password with one keyboard layout and subsequently change to a keyboard with a different layout, i.e., one that will be misunderstood by the BIOS. If this were to occur, the user may not be able to supply a matching password although he/she may appear to be inputting the same sequence of keys.

The present disclosure may provide methods for the handling of keyboard inputs.

### SUMMARY

The following presents a general summary of some of the many possible embodiments of this disclosure in order to provide a basic understanding of this disclosure. This summary is not an extensive overview of all embodiments of this disclosure. This summary is not intended to identify key or critical elements of the disclosure or to delineate or otherwise limit the scope of the claims. The following summary merely presents some concepts of the disclosure in a general form as a prelude to the more detailed description that follows.

According to one embodiment, a computer implemented method of processing keyboard input is disclosed. The method includes receiving a keyboard type of a keyboard coupled to an information handling system, receiving keyboard input from the keyboard and processing the keyboard input as a function of the keyboard type.

According to another embodiment, a computer implemented method of processing keyboard input is disclosed. The method includes receiving keyboard input from a keyboard coupled to an information handling system and determining keyboard type by comparison of the keyboard input to a predetermined character string.

According to yet another embodiment, a computer implemented method of processing keyboard input is disclosed. The method includes receiving keyboard input from a keyboard coupled to an information handling system, determining all combinations for the keyboard input, receiving a subsequent keyboard input and comparing the combinations with the subsequent keyboard input.

According to another non-limiting embodiment, a computer implemented method of processing keyboard input is disclosed. The method includes receiving a keyboard input comprising at least one identifier key, substituting a value in the place of the identifier key to produce a mapped keyboard input and comparing the mapped keyboard input to an authenticating password.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus for a detailed understanding of this disclosure, reference should be made to the following detailed description, taken in conjunction with the accompanying drawings, in which like elements have been given like numerals.

FIG. 1 depicts an illustrative embodiment of an information handling system (IHS).

FIG. 2 depicts an illustrative embodiment of a first possible method of the present disclosure.

FIG. 3 depicts an illustrative embodiment of a second possible method of the present disclosure.

FIG. 4 illustrates a chart correlating keys with keyboard type.

FIG. 5 depicts an illustrative embodiment of a third possible method of the present disclosure.

FIG. 6 depicts an illustrative embodiment of a fourth possible method of the present disclosure.

### DETAILED DESCRIPTION

For purposes of this disclosure, an embodiment of an Information Handling System (IHS) may include any instrumentality or aggregate of instrumentalities operable to compute, classify, process, transmit receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

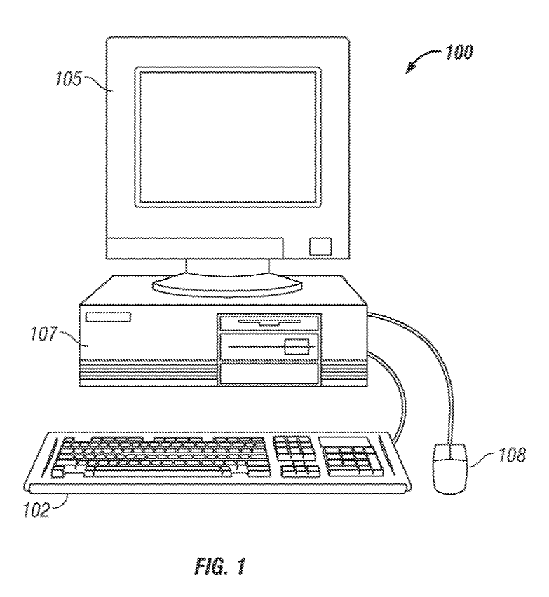

Referring now to FIG. 1 an information handling system (IHS) 100 having a keyboard 102, monitor 105, housing 107 and mouse 108 is shown. For purposes of this disclosure, IHS 100 may represent any IHS as described above, and not limited to the configuration as shown in FIG. 1. Keyboard 102 may be any suitable keyboard as is known in the art. Keyboard 102 may be stand alone as shown or may be incorporated into any part of the IHS, including into a notebook, or an integrated IHS system.

A scan code is the data that most keyboards send to an IHS to report which keys have been pressed. As a non-limiting description, circuitry within the keyboard senses key depression/actuation and an on-board microprocessor generates a unique hexadecimal code on the output line corresponding to the location of the actuated key. One code is generated when the key is pressed (the make code) and a different code is generated when the key is released (the break code). Make codes are necessary for all keys while break codes are essential only for modifier keys such as Shift, Control and Alt. Scan codes are converted by the terminal logic unit software to the characters, modifiers (Left Shift, Right Shift, Left Control, Right Control, Left Alt, Right Alt) or functions (e.g. Print, Help, Clear, Play, etc.) inscribed on the key. Some keyboards offer optional sets of scan codes selectable by the user, but the code for each key is always known.

In some embodiments, keyboard output may be provided to a driver (which may be software or firmware) that recognizes and converts the incoming scan codes to formats including, but no limited to, American Standard Code for Information Interchange (ASCII) or Extended Binary Coded Decimal Interchange Code (EBCDIC) characters. By way of example, ASCII and EBCDIC codes are then read as input data by the application program.

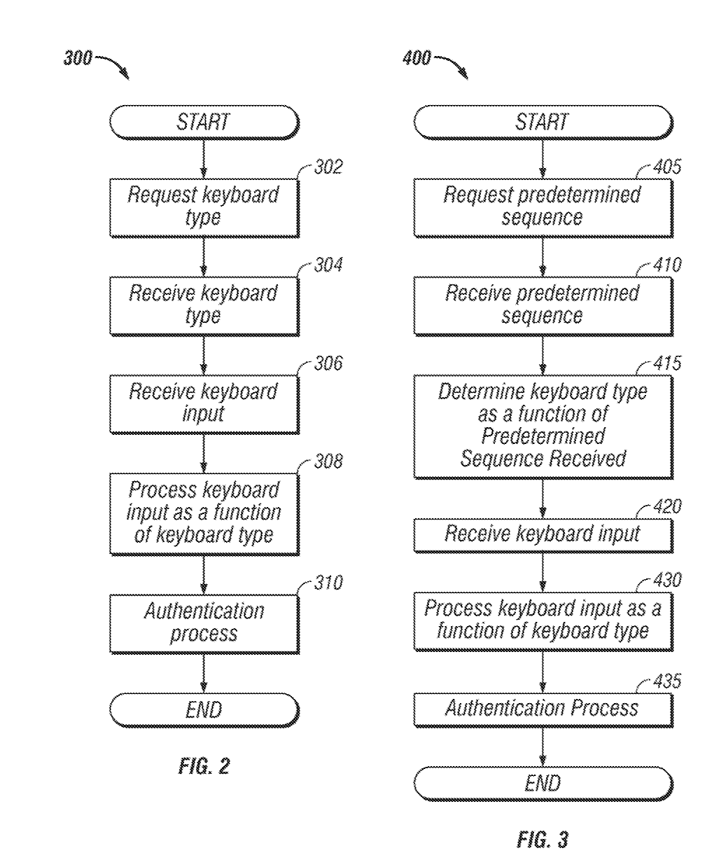

FIG. 2 depicts a schematic representation of a non-limiting method embodiment 300 of the present disclosure for processing keyboard inputs. Various methods 300 may be contemplated comprising all or less than all of the steps shown, any number of repeats of the steps shown, and in any order.

In step 302 the user may be requested to input the type of keyboard being utilized. Because the assumption is that the type of keyboard utilized is not known, care should be taken to request identity of the keyboard type through the use of keys that are common across many types of keyboards. By way of example, arrow keys are common across a number of keyboard types and may be utilized to select a keyboard type from a provided list. As another non-limiting example, many of the function “F” keys are common across keyboards, as are the number keys and a few of the alpha keys. Pull down selection menus, as well as lists from which a selection is made, are merely examples of convenient methods of allowing a user to identify the keyboard type.

In step 304 the keyboard type input by the user will be received by the IHS. The IHS now processes further input received from the keyboard as coming from a keyboard of the type inputted. For example, if a US English keyboard type is input, subsequent keyboard input is processed as coming from a US English keyboard.

In step 306 subsequent keyboard input is received by the IHS. Once the keyboard type is input in step 304, further keyboard input may be received by the IHS. As examples, this further keyboard input may be information for word processing, email, spreadsheet, accounting, password authentication, or any other program. In some embodiments of this disclosure, this further keyboard input handled by the BIOS relates to authentication, and the program is an authentication program. As a non-limiting example, a password may be received by the information handling system.

In step 308, this keyboard input is processed as a function of the keyboard type. In other words, if the keyboard type was received in step 304 as a French keyboard, the keyboard input is processed accordingly. In step 310, the particular program, for example, the BIOS, word processing, email, spreadsheet, accounting, password authentication, or any other, will then handle the keyboard input with the scan codes mapped to a French keyboard. For example, if a password was provided in step 306, it may be processed in step 308 in an authentication program.

Various embodiments of this method contemplate repeating the steps of receiving keyboard input (306), processing keyboard input (308), and then processing the input within a software program.

Referring now to FIG. 3, a schematic representation of a non-limiting method embodiment 400 of the present disclosure for processing keyboard inputs is shown. Various methods 400 are contemplated comprising all or less than all of the steps shown, any number of repeats of the steps shown, and in any order. In step 405 the user is requested to enter a predetermined sequence of keystrokes. Requesting the input of keystrokes may help identify which keyboard is being utilized. In general, keystrokes tend to be different from keyboard to keyboard.

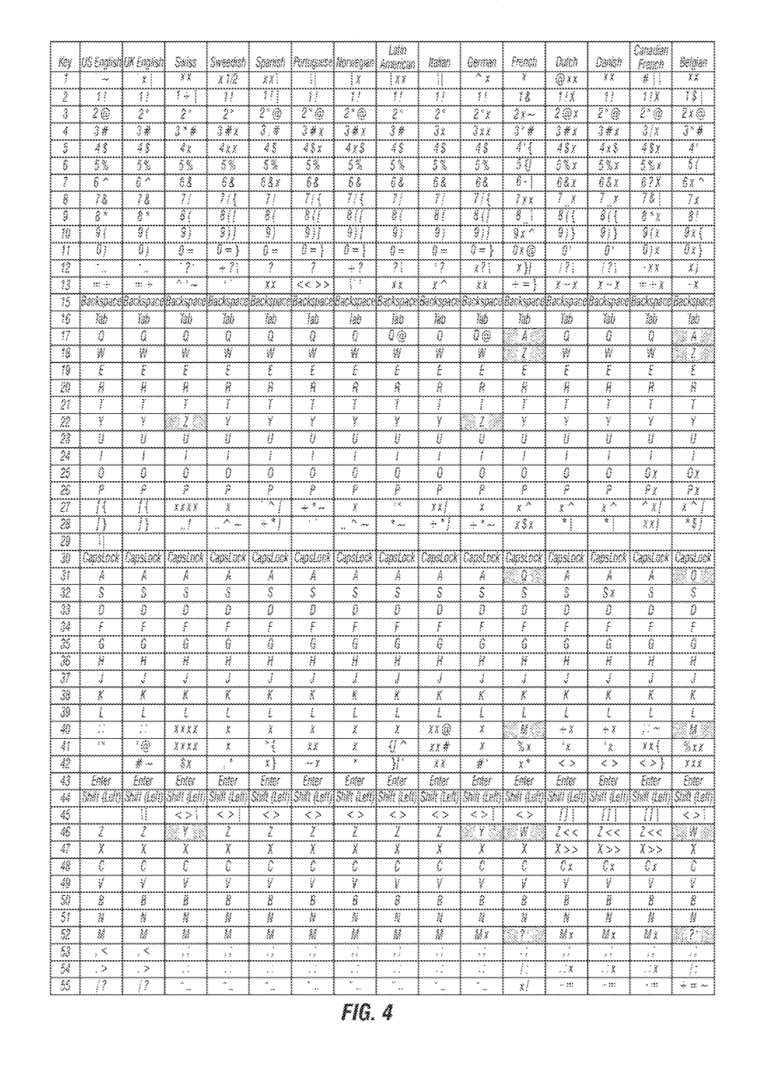

Referring now to FIG. 4, a chart is shown depicting key versus keyboard type for a number of keyboard types. The chart herein was extracted from the IBM Technical Reference Manual. Notice that there are different degrees of correlation between the keyboards depending upon the key selected. There is “no correlation” for a number of the symbol keys, for example, key nos. 27, 28, 40, 41 and 42. Certain keys, such as A, Z, Q, M, W, Y and “?” are rogue keys which might be different on only one or two keyboards. There is correlation on, for example, key nos. 15, 16, 19, 20, and 33-39. There is near correlation on key nos. 17, 18, and 45.

It is possible to identity some keyboards with a single keystroke. For example, if a request is made for “@” the UK English keyboard returns a unique key no. 41, the Italian keyboard returns a unique key no. 40, and the French keyboard returns unique key no. 11. An identifier key no. 3 is returned by the U.S. English, Spanish, Portuguese, Norwegian, Dutch, Danish, Canadian French, Belgian or other language keyboards. A key may be an identifier key when its location on a particular keyboard type or language keyboard differs from its location on a differing keyboard type. By way of example, the “Z” and “Y” are identifier keys since their locations on the Swiss and German keyboards are swapped when compared to a US keyboard. To provide some margin for error, the requested sequence may be requested to be entered more than once, and/or may be of sufficiently long length to more conclusively identify the keyboard.

Referring back to FIG. 3, in step 410 the subsequent keyboard input is received by the IHS. In step 415 the keyboard type is determined as a function of the predetermined sequence requested and the actual keyboard input received. The actual determination of the keyboard type may be made in any number of ways. For example, as discussed above, certain unique keys will point to one and only one possible keyboard. As a non-limiting example, for “@” the UK English keyboard returns a unique key no. 41, the Italian keyboard returns a unique key no. 40, and the French keyboard returns unique key no, 11. As another example, certain unique combinations will point to one and only one possible keyboard. The determination of keyboard type may be made using the scan codes or the characters that correlate to the actual keyboard input.

In step 420 the keyboard input is received by the IHS. As non-limiting examples, this keyboard input may be information for BIOS, word processing, email, spreadsheet, accounting, password authentication, or any other program. In some embodiments of this disclosure, the information relates to authentication, and the program is an authentication program.

In step 430 the keyboard input is processed according to the keyboard type identified above in step 415. This keyboard input may be processed in software, non-limiting examples of which include BIOS, word processing, email, spreadsheet, accounting, password authentication, or any other software.

In some embodiments of this disclosure, the keyboard input is a password and is processed as being input on the identified keyboard type. Authentication is then made by comparison of the input password to the stored password as is known to those of skill in the art.

Various embodiments of this method contemplate repeating the steps of receiving keyboard input (420) and processing the keyboard input (430).

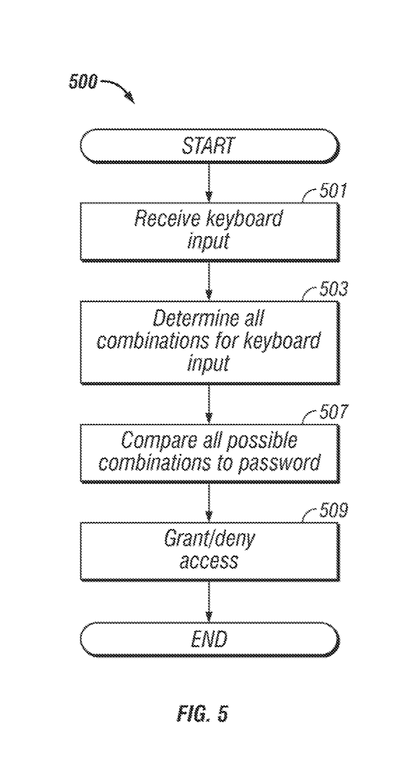

Referring now to FIG. 5, a schematic representation of a non-limiting method embodiment 500 of the present disclosure for processing keyboard inputs is shown. Various methods are contemplated comprising all or less than all of the steps shown, any number of repeats of the steps shown, and in any order.

In step 501, keyboard input is received by the information handling system. As non-limiting examples, this keyboard input may be information for BIOS, word processing, email, spreadsheet, accounting, password authentication, or any other program. In some embodiments of this disclosure, the keyboard input is a password, and the program is an authentication program.

In step 503 all possible combinations that can be generated by the received keyboard input are generated. For example, for key nos. 18 20 31, the possible selections for those key nos are W or Z for key 18, R for key 20, and A or Q for key 31, with the possible combinations being WRA, WRQ, ZRA, ZRQ. These combinations may be in the form of scan codes, characters or alphanumeric data that correlate to the actual keyboard input.

In step 507 the information is processed in all of its permutations, in any desired software. In a non-limiting embodiment, all possible combinations of the keyboard input are then compared to the stored password. Access is granted if any of the possible combinations match with the stored password. Alternatively, the stored password can be expressed in terms of possible keyboard input and then compared with the actual keyboard input.

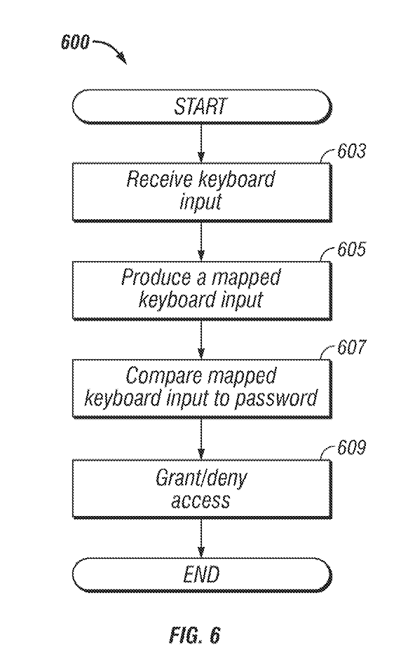

FIG. 6 depicts a schematic representation of a non-limiting method embodiment 600 of the present disclosure. Various methods are contemplated comprising all or less than all of the steps shown in FIG. 6, any number of repeats of the steps shown, and in any order.

In step 603, a keyboard input comprising at least one identifier key may be received by an IHS. In step 605, a mapped keyboard input is produced by substituting a value in the place of the identifier key. The value may include but is not limited to a number, character or alphanumeric data. Furthermore, the value may correlate to a key of a particular keyboard type or language keyboard. As a non-limiting example, the keyboard type/language may be US English or any other type as shown in FIG. 4. The method in FIG. 6 may also include step 607 of comparing the mapped keyboard input to an authenticating password. The authenticating password may be predetermined or preexisting. Step 609 may include granting or denying access in the event the mapped keyboard input matches or does not match the authenticating password.

The following descriptions to embodiments of the present disclosure are set forth for the purpose of explanation and not limitation, to provide a thorough understanding of the present invention. A password of “AZERTY” is received by an IHS. This password has 3 identifier keys: the “A,” the “Z,” and the “Y.” Assigning a value of “1” for “A,” and “2” for “Z” and “3” for “Y,” maps “AZERTY” to “12ERT3.” Therefore, “AZERTY” entered on any keyboard type/language will be mapped to an identical mapped keyboard input. i.e., “12ERT3.” As another non-limiting alternative, the identifier keys could be mapped to their US English value. Therefore, “AZERTY” entered on any keyboard type/language will be mapped to an identical mapped keyboard input, i.e. “QYERTY.”

Portions of the present disclosure, detailed description and claims may be presented in terms of logic, software or software implemented aspects typically encoded on a variety of media including, but not limited to, computer-readable media, machine-readable media, program storage media or computer program product. Such media may be handled, read, sensed and/or interpreted by an information handling system (IHS). Those skilled in the art will appreciate that such media may take various forms such as cards, tapes, magnetic disks (e.g., floppy disk or hard drive) and optical disks (e.g., compact disk read only memory (“CD-ROM”)) or digital versatile disc (“DVD”)). It should be understood that the given implementations are illustrative only and shall not limit the present disclosure.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

What is claimed is:

1. A computer implemented method of processing keyboard input, comprising:
receiving a keyboard type of a keyboard coupled an information handling system;
receiving keyboard input from the keyboard; and
processing the keyboard input as a function of the keyboard type.

2. The method of claim 1, wherein the keyboard input is a password, and processing comprises authenticating the password.

3. The method of claim 2, wherein the keyboard input is handled by the Basic Input/Output System (BIOS).

4. The method of claim 1, wherein the step of receiving the keyboard type comprises receiving a selection from a list of keyboard types.

5. The method of claim 1, comprising an initial step of:
requesting input of the keyboard type.

6. A computer implemented method of processing keyboard input, comprising:
receiving keyboard input from a keyboard coupled to an information handling system; and
determining keyboard type by comparison of the keyboard input to a predetermined character string.

7. The method of claim 6, wherein the determining of keyboard type is determined by an algorithm.

8. The method of claim 6, comprising an initial step of:
requesting input of a predetermined character string.

9. The method of claim 6, further comprising:
receiving a subsequent keyboard input from the keyboard.

10. The method of claim 9, further comprising;
processing the subsequent keyboard input as a function of the keyboard type.

11. The method of claim 10, wherein the subsequent keyboard input is a password, and processing comprises authenticating the password.

12. The method of claim 6, wherein the predetermined input string uniquely identifies the keyboard type.

13. A computer implemented method of processing keyboard input, the method comprising:
receiving a keyboard input comprising at least one identifier key;
substituting a value in the place of the identifier key to produce a mapped keyboard input; and
comparing the mapped keyboard input to an authenticating password.

14. The method of claim 13, wherein the keyboard input is handled by the BIOS.

15. The method of claim 13, wherein the step of comparing comprises granting access if the mapped keyboard input matches the authenticating password.

16. The method of claim 13 wherein the step of comparing comprises denying access if the mapped keyboard input does not match the authenticating password.

17. The method of claim 13, wherein the value correlates to a key as found on a keyboard type.

18. The method of claim 17, wherein the keyboard type is a US English.
